(19) United States
(12) Patent Application Publication
(10) Pub. No.: US 2003/0041125 A1
(43) Pub. Date: Feb. 27, 2003

(54) Internet-deployed wireless system

(76) Inventor: Kirk C. Salomon, Renton, WA (US)

Correspondence Address: PENNIE AND EDMONDS, 1155 AVENUE OF THE AMERICAS, NEW YORK, NY, 100362711

(21) Appl. No.: 09/931,425

(22) Filed: Aug. 16, 2001

(51) Int. Cl. G06F 15/177; G06F 15/16

(52) U.S. Cl. 709/220; 709/203

(57) ABSTRACT

Disclosed is an Internet-deployed wireless system comprising an application server program configured to be downloaded to and to execute on one or more remote wireless application server computers. The application server program is also configured to cause the one or more remote application server computers to download and to install one or more wireless application software components. The application server program is further configured to transmit to one or more portable devices one or more client applications and to cause the one or more portable devices to install the one or more client applications. The client applications are configured to communicate with a local wireless application server computer over a wireless network.

### BACKGROUND OF THE INVENTION

Current high-speed wireless technology such as bluetooth and IEEE 802.11 require that wireless clients be within a few hundred feet of a wireless access point. This limitation renders deployment of wireless applications over a large geographic area technically complex. Moreover, due to the complexity of such systems, skilled technicians are needed for installation and maintenance.

For example, because the latency and dependability of such wireless technology often requires 3-tier or n-tier architectures, centralized server-based Internet-driven wireless enterprise applications are plagued with problems stemming from complexity in integrating system components, configuring deployed wireless systems, and controlling license usage and entitlement. In mission-critical applications that businesses have come to demand from their wireless systems, these drawbacks prevent mobile centralized server-based Internet-driven enterprise applications from being an acceptable solution for deploying a single wireless application over a large geographic area.

Therefore, there is a need for a wireless system that is simple to deploy and maintain so that anyone with basic Internet skills can deploy the wireless system. In addition, there is a need for a flexible wireless system that is able to quickly and easily distribute different wireless software applications to different remote sites, tailoring those wireless software applications to the unique needs of each remote site, while complying with the license terms of the vendors of those applications. There is also a need for a wireless system that addresses latency problems, is inexpensive to deploy, and is dependable.

### SUMMARY OF THE INVENTION

In one aspect, the present invention comprises an application server program configured to be downloaded to one or more remote wireless application server computers and to execute on the one or more remote wireless application server computers, the application server program being further configured to cause the one or more remote application server computers to download and to install one or more wireless application software components on the one or more remote wireless application server computer; the one or more wireless application server program being configured to transmit to one or more portable devices one or more client applications and to cause the one or more portable devices to install the one or more client applications; the client applications being configured to communicate with the local wireless application server computer over a wireless network.

In another aspect, the present invention further comprises a license server configured to update a database of license information in response to execution of the wireless application software and to cause notifications of charges to be generated based on the license information.

In still another aspect, the invention further comprises a central application server configured to transmit the application server program and the one or more wireless application software to the one or more local wireless application server computers.

In yet another aspect, the application server program is further configured to download and to install a different set of wireless application server on different local wireless application server computers.

In another aspect, application data is processed and filtered by the one or more local application server computers before transmitting the pre-processed and filtered data to the central application server.

In another aspect, the application server program is further configured to cause the one or more local application server computers to update one or more wireless application software programs on the one or more local wireless application server computers.

### BRIEF DESCRIPTION OF THE DRAWINGS

FIG. 1 is a block diagram schematically illustrating a preferred Internet-deployed wireless system according to the invention;

FIG. 2 is a diagram schematically illustrating in more detail the preferred Internet-deployed wireless system according to FIG. 1;

FIG. 2A schematically illustrates application server.

FIG. 3 schematically illustrates license usage database and license detail database;

FIGS. 4A-C is a flowchart schematically illustrating the Internet-deployment process according to the invention; and

FIG. 5 schematically illustrates one preferred embodiment of a XML configuration document.

### DETAILED DESCRIPTION OF THE PREFERRED EMBODIMENT

In one aspect, the present invention is directed to an Internet-deployed multi-tier wireless software application server system having at least three tiers that allows an end-user with modest technical skills at a remote site to download an application server program that enables the end-user to download, update, install, and configure licensed wireless application software and associated licenses from a central site with a few clicks on a Web browser. The wireless application software is preferably preconfigured for a particular remote site to suit its unique needs. This increases the flexibility of the wireless system and reduces license costs, since only the wireless application software appropriate for the remote site is downloaded. Furthermore, the multi-tier structure of the present Internet-deployed wireless system, including the central site, the remote site, and mobile devices, reduces latency in execution of the wireless applications and increases the efficiency of central site operations. Specifically, the remote site caches, processes, and filters data before transmitting the pre-processed and filtered data to the central site, which conserves communication bandwidth and processing power at the central site.

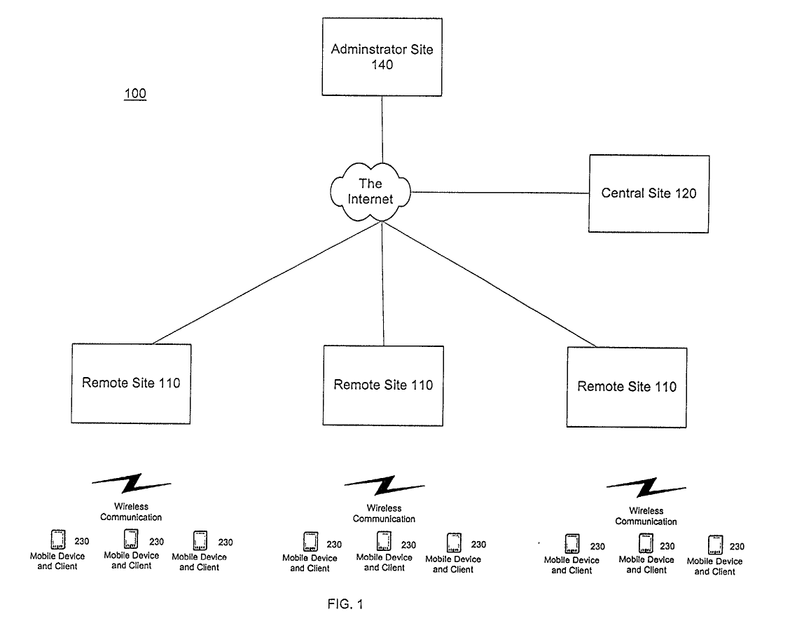

FIG. 1 depicts a preferred embodiment of the Internet-deployed wireless system 100. As shown in FIG. 1, system 100 preferably includes one or more remote sites 110, a central site 120, one or more mobile devices 230, and one or more administrator sites 140. Remote sites 110, central site 120, and administrator site 140 are preferably connected via the Internet whereas remote sites 110 and mobile devices 230 preferably communicate using wireless technology.

Remote sites 110 are preferably branches of a company distributed over a large geographic area that remotely execute business applications such as transactions processing software in conjunction with mobile devices 230 and central site 120. Remote sites 110 automatically download, update, install, and configure wireless application software from Central Site 120 over the Internet for use in executing the business applications. Remote site 110 also caches, processes, and filters data flowing between wireless application software executing on mobile devices 230 and central site 120 in order to conserve bandwidth and processing power of central site 120. For example, in one preferred business application, mobile devices 230 include bar code scanners and execute parcel tracking software for maintaining tracking information concerning parcels in transit in a database at central site 120. In this preferred example application, remote site 110 serves as a cache for database transactions.

Central site 120 is schematically depicted as a single site, but may comprise a number of server computers operating at one or more locations by one or more entities. For example, in one embodiment, central site 120 may be managed by the company itself. In an alternative embodiment, central site 120 may be managed by an entity that specializes in managing distribution of wireless software applications for companies. In other alternative embodiments, one or more of the various aspects of the central site described below may reside at the company while other aspects of central site are located at the managing entity. In yet another alternative embodiment, the central site 120 may be located at one company that has a wireless system of its own, but also distributes the wireless application software to that company's customers or affiliates.

Central site 120 preferably comprises four aspects: (i) one or more application server programs that process application data or otherwise interoperate with wireless applications executing on wireless devices intermediated by remote site computers; (ii) one or more wireless application software repositories for storing wireless application software to be installed on remote site computers 210 and wireless devices 230; (iii) one or more license server programs that track installation and use of wireless application software to support collection of payment in accordance with license terms and prevent installation and use in violation of license terms; and (iv) one or more configuration repositories that store information defining the configuration of the wireless application environment at one or more remote sites at which wireless applications will be deployed by the system.

Mobile devices 230 are preferably handheld devices that execute wireless applications that interoperate with remote sites 110 and cause application data to be transmitted back to the remote site 110. Mobile devices 230 communicate with remote site 110 using wireless teclutology and are able to move freely unconstrained by wires.

Parameters that designate wireless software applications to be downloaded to remote sites 110 and their associated software licenses are preferably provided at administrator site 140. In addition, information defining the configuration of the wireless application environment at one or more remote sites is also provided at administrator site 140. For example, in one preferred embodiment, a corporate information technology specialist has responsibility for providing license and configuration information for many or all of the remote sites of the company.

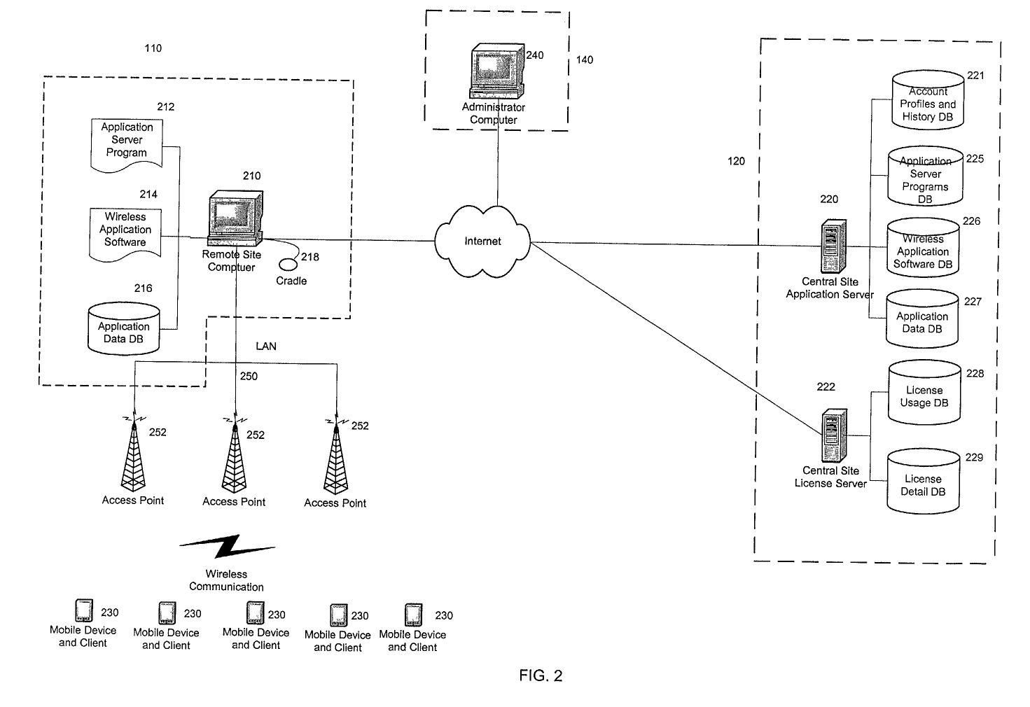

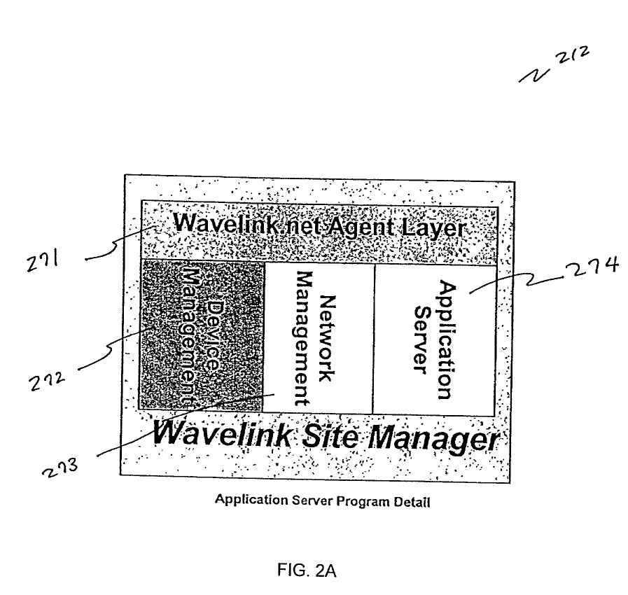

FIG. 2 depicts, in further detail, the preferred embodiment of the Internet-deployed wireless system 100. As shown in FIG. 2, system 100 preferably includes a remote site computer 210, a central site application server 220, a central site license server 222, an administrator computer 240, a local area network (LAN) 250, one or more access points 252, and one or more mobile devices 230.

Remote site computer 210 and administrator computer 240 are preferably connected to central site application server 220 and central site license server 222 through the Internet. In addition, remote site computer 210 preferably communicates with mobile devices 230 via LAN 250 and wireless access points 252. Specifically, remote site computer 210 is connected to wireless access points 252 through LAN 250; access points 252, in turn, communicate with mobile devices 230 using wireless local area network technology. The system interface, wireless protocol layer, and wireless LAN adapters of access points 252 are preferably 802.11 Standard compliant.

Remote site 110 includes a remote site computer 210 which, in turn, includes an application server program 212, wireless application software 214, and an application data database 216. Remote site computer 210 can run various operating systems such as Microsoft NT, Microsoft 2000, Linux, or Unix. Application server program 212 may be executed on one or more remote site computers 210 and enable those remote site computers 210 to download and run wireless software applications 214 to interoperate with mobile devices 230 and central site 120 to carry out transactions or other business activities.

Specifically, application server program 212 enables remote site computer 210 to automatically download, install, and configure wireless application software from central site application server 220. Application server program 212 also enables remote site computer 210 to acquire licenses associated with the downloaded wireless application software via the Internet from central site license server 222. In addition, application server program 212 allows an end-user at the remote site to determine which wireless application software have been installed and configured at the remote site. Moreover, application server program 212 enables remote site computer 210 to transmit a client to mobile device 230 so that mobile device 230 can communicate with remote site computer 210.

Application server program 212 is schematically illustrated in greater detail in FIG. 2A. Application server program 212 comprises Wavelink.net agent layer 271, Wireless Device Management 272, Wireless Network Management 273, and Wireless Application Server 274.

The Wavelink.net agent portion 271 of the application server program 212 provides product deployment capability, product licensing capability, product support capability, data services and management, enterprise integration, user management and profiles, administrative capabilities, and core security layers including encryption and authentication.

The Wireless Device Management portion 272 of application server program 212, in concert with one or more Wavelink enabled wireless devices, provides over-the-air device software and configuration upgrades of business applications, support for remote site wireless devices from a central location, support for a heterogeneous installed base of wireless devices, hardware and software configuration capture, monitoring and management of wireless devices from the central site, data synchronization capabilities to mobilize enterprise applications, file backup from mobile and wireless devices to secure servers, initiation of remote action on servers by mobile devices and other client/server interaction, open standard XML data transport protocol, seamless roaming across network subnets, session persistence through out-of-range conditions, session persistence through suspend/resume (battery management), compression for low-bandwidth conditions, and security, including encryption, user authentication, roamable virtual private network functionality, real-time status monitoring, connection activity logging, and event logging for troubleshooting.

The Wireless Network Management portion 273 of application server program 212 supports auto-discovery and profiles for access points, remote and secure wireless network administration, remote configuration and monitoring of access points, wireless LAN security, wireless LAN monitoring, and diagnostics and alert notifications by E-Mail or Web.

The Wireless Application Server 274 of application server program 212, supports a middleware server that hosts applications that have been developed with Wavelink Studio, a middleware server that provides real-time access to Wavelink hosted applications, a middleware server that integrates back office servers to Wavelink enabled wireless devices providing real-time access to enterprise data supporting core functions such as SFA, CRM, ERP, E-Mail and calendaring and database queries, and a middleware server that enables people working out-of-office to safely and securely access the company network over the Internet using Wavelink enabled wireless devices.

Referring back to FIG. 2, wireless application software 214 interoperates with mobile device 230 and central site application server 220 and is available in various computer languages such as VB, Java, and C++ and for various operating systems such as Microsoft NT, Microsoft 2000, Linux, Unix, or Macintosh. Application data database 216 serves as persistent storage for remote site computer 210.

Central site 120 includes a central site application server 220 that stores and transmits wireless application software to remote sites 110 over the Internet and preferably comprises Microsoft Internet Information Server and Microsoft SQL Server 2000. Central site application server 220 includes an application server programs database 225, a wireless application software database 226, an application data database 227, and an account profiles and history database 221.

Application server programs database 225 and wireless application software database 226 store application server programs and wireless application software respectively. Application data database 227 stores data flowing from execution of wireless application software. Account profiles and history database 221 stores information concerning configuration of the wireless application environment at remote site computers 210 and mobile devices 230 at which wireless application software will be deployed. Such information preferably includes the operating system of remote site computer 210 and mobile devices 230 as well as wireless application software 214 already installed on remote site computer 210 and mobile devices 230, including version information for software 214. It also preferably includes user account and authentication information.

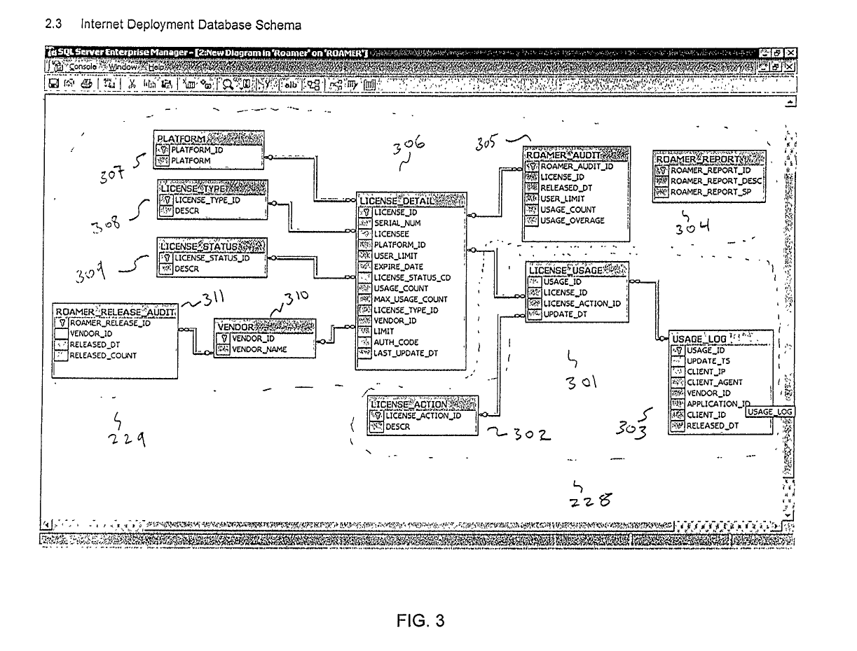

Central site also includes a central site license server 222 that stores and manages the distribution of wireless application licenses and preferably comprises Microsoft SQL Server 2000. The server 222 includes a license usage database 228 and a license detail database 229 that are depicted in further detail in FIG. 3. These databases 228 and 229 are used for tracking of licensing, deployment and use of wireless application software for purposes of enforcing licenses and charging fees for use of wireless application software.

As schematically illustrated in FIG. 3, license usage database 228 and license detail database 229 preferably comprise a number of tables in a relational database. The license detail database 229 is transactional and is updated in real time to reflect the current licensing status and use of software at remote sites 110. By means of the license detail database 229, the system assigns and releases licenses to entities seeking to deploy or use wireless application software in real time. The license usage database 228 is updated to maintain a historical record of license and use information.

License detail database 229 stores information describing each license. The license detail database 229 preferably comprises license detail table 306, vendor table 310, roamer release audit table 311, license status table 309, license type table 308, platform table 307, roamer audit table 305 and roamer report table 304. The license detail table 306 is central to the license detail database 229. The serial number field contains the serial number of the license. The licensee field identifies the licensee. Platform ID field identifies a record in the platform table for the platform (for example Sparc/Solaris) that the application associated with the license runs on. The User Limit field identifies the number of simultaneous users permitted under the license. The expire date field identifies the expiration date of the license. The license status ID identifies a record in the license status table that contains information describing current status of the license. The usage count field contains information regarding the number of times the license has been used. The max usage count field contains the maximum number of times the license may be used. The vendor ID indexes a table that contains vendor names. The auth code field contains an authorization code for the license. Last update DT field identifies the last date on which the license was updated.

License usage database 228 preferably comprises a license usage table 301, usage log table 303, and license action table 302.

The license usage table 301 preferably includes the following fields: license ID, update DT, license action ID, and usage ID. The license ID field identifies a particular license. The update DT field contains the date on which the license was last updated. The license action ID field identifies a record in the license action table that contains a detailed description regarding a particular usage of the license. Examples of preferred license actions include “install,” “remove,” “add user,” and “delete user.” The usage ID field identifies a record in the usage log table 303 that contains details concerning license usage.

Usage log table 303 comprises a usage ID primary key, an updateTS timestamp field indicating the date and time of the last update, a client_IP field indicating the Internet protocol address of the client associated with the usage log record, a Client Agent field indicating the client agent program associated with the usage log record, a Vendor ID field indicating the vendor of the client agent program, an application ID field indicating the application program with which the client program is used, and a client ID field identifying the end-user associated with the usage log record.

The license detail database 229 and license usage database 228 interoperate with the administrative computer 240 (FIG. 2) and remote site computer 210 (FIG. 2) to provide a variety of license tracking and management capabilities. Applications supported by the system and used by each remote site, along with information describing the vendor and platform of each application installation, are stored in the license detail table 306, vendor table 310, platform table 307 and usage log table 303. The maximum number of users permitted under a license is stored in license detail table 306 and checked by the system against a usage count that is updated in real time. The maximum number of concurrent users is also stored in the license detail table 306 and license type table 308, allowing “floating” licenses if permitted by the license type. The maximum number of allowed users is checked by the system against a maximum usage count that is updated in real time. A maximum grace level of usage (e.g., an amount of time and number of concurrent users allowed before further use is denied) is also stored and checked using the license detail table 306, license type table 308, license status table 309, license usage table 301, and license action table 302. A wide variety of licensing models maybe supported and monitored in real time using these reporting structures.

As described above, the license detail 306 and license usage 301 tables are updated in real time and permit real-time reporting of license activity, as well as checking current usage against license constraints. Audit trails of licenses, including times, dates and durations of use, applications used, customers that have used the licenses, and vendors that provided the licenses, are created and may be monitored using the license detail table 306, roamer release audit table 311, vendor table 310, roamer audit table 305, license usage table 301 and usage log table 303. Aggregate license reporting may also be provided from information stored in the license detail table 306, license usage table 301, usage log 303, and roamer report tables 304. Alerts, notifications and business process triggers, including automatic billing and license limit notices, are provided by monitoring license detail table 306, roamer release audit table 311, roamer audit table 305, usage log 303, and roamer report table 304. Although not shown in FIG. 3, real-time data is generally timestamped by the database system, and transactions are implemented using a two-phase commit with roll-back if the transaction is not completed.

Referring back to FIG. 2, mobile device 230 interoperates with wireless application software 214 running on remote site computer 210 and central site application server 220. The client program that mobile device 230 uses to communicate with remote site computer 210 is preferably the WaveLink Studio Client available from Wavelink Corporation 11332 NE 122^{nd} Way, Suite 300, Kirkland, Wash. 98034, USA and is preferably downloaded from remote site computer 210 using a cradle 218 attached to remote site computer 210. In an alternative embodiment, the client may be downloaded to the mobile device 230 using wireless technology such as Wavelink Avalanche wireless technology. Mobile device 230 preferably includes an operating system, a RF LAN adaptors, and a RF antenna compliant with 802.11 Standard.

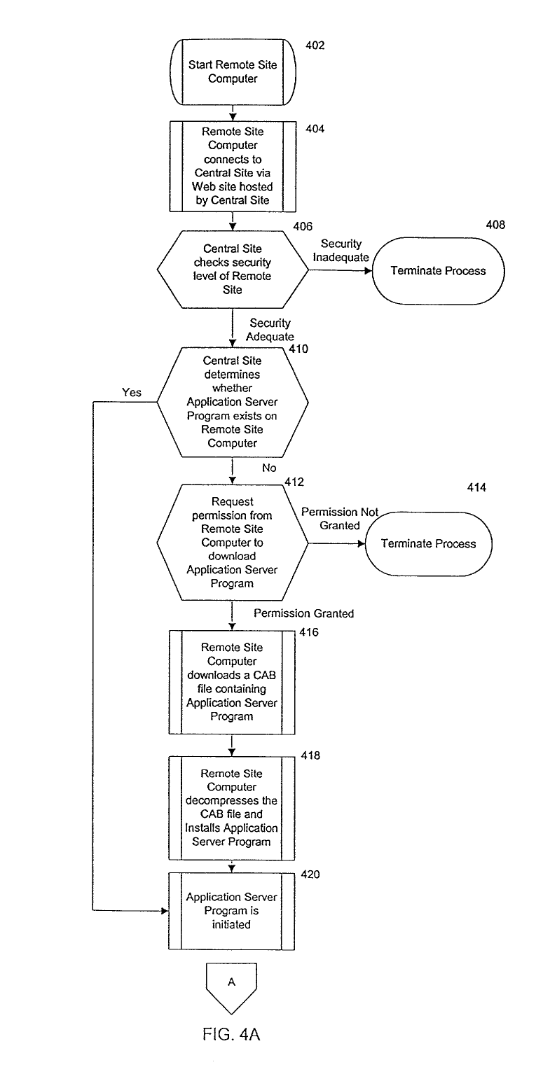

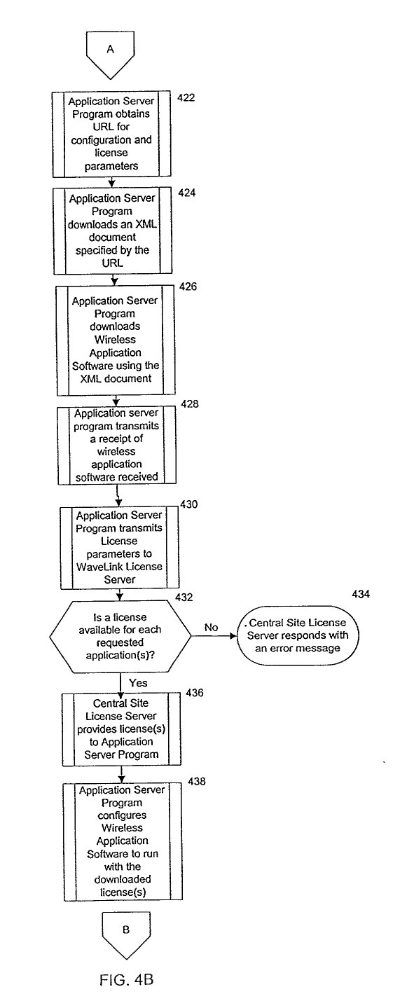

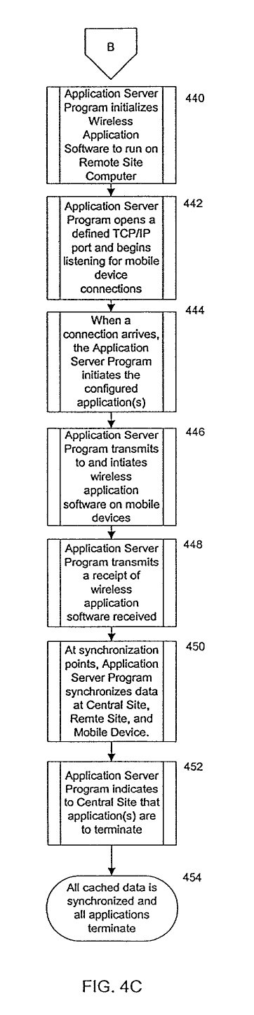

The wireless network 100 as described above deploys and executes wireless application software 214 using the preferred process described below and illustrated in FIGS. 4A-4C.

As depicted in step 402 of FIG. 4, deployment of wireless application software begins with an end-user turning on remote site computer 210 and, in step 404, connecting it to central site application server 220 by entering into remote site computer's Web browser a URL for a Web site hosted by the central site application server 220. In step 406, central site application server 220 checks the security level at remote site computer 210 by requiring authentication from remote site computer 210 and comparing the authentication received with authentication information stored in account profiles and history database 221. If server 220 determines that the security level at remote site computer 210 is inadequate, the process is terminated in step 408. If the security level is adequate, central site application server 220 proceeds to step 410 where it determines whether remote application server program 212 is already installed on remote site computer. This determination preferably involves central site application server 220 transmitting a Web page containing a query asking the end-user whether remote application server program 212 is installed on remote site computer 210. Alternatively, central site application server 220 may perform this step automatically by transmitting an Active X control that checks for the library files (DLLs) for the remote application server on the remote site computer.

If central site application server 220 determines that application server program 212 is already installed on remote site computer 210, the process advances to step 420 where remote site computer 210 initiates application server program 212. However, if remote site computer 210 does not have remote application server program 212, central site application server 220 requests permission from the end-user to download the program in step 412. This request is preferably made by transmitting a Web page to the remote site computer Web browser that contains a query requesting permission from the end-user to download application server program 212. If permission is not granted, the process is terminated in step 414. However, if permission is granted, in step 416, remote site computer 210 downloads a compressed file (preferably in Microsoft cabinet or CAB format) containing the application server program 212 from central site application server 220. In steps 418 and 420, remote site computer 210 then decompresses the compressed file and installs, and initiates application server program 212.

In step 422, the initiated remote application server program 212 obtains from central site application server 220 license and configuration parameters for downloading wireless application software 214. Remote application server program 212 preferably obtains the configuration and license parameters in step 422 by downloading a Web page containing license parameters and the URL of a configuration file embedded as script parameters within the Web page. The script is parsed and the script parameters including the license parameters and the URL are passed to the remote application server program 212. An example of script comprising such an embedded URL for a configuration file that may be inserted into the parameter-embedded Web page is:

<OBJECT name=objRoamer id=objRoamer height=0 width=0

classid=clsid:73668804 - 3BB8 - 11D4 - BB20 - 0050DA22767
CODEBASE = “WLRoamer.CAB#version = 1,0,0,20”
VIEW ASTEST
<PARAM NAME = “Config” VALUE = http://yourhost/app.xml>
<PARAM NAME = “VID” VALUE = “1”>
<PARAM NAME = “AID” VALUE = “1”>
<PARAM NAME = “CID” VALUE = “1”>

</OBJECT>

In the foregoing example embodiment, the script parameter defined by <PARAM NAME=“Config” VALUE=http://yourhost.app.xml> defines a URL for an XML file that includes licensing and configuration information for the remote site computer 210. The script parameter defined by <PARAM NAME=“VID” VALUE=“1”> defines a vendor identifier of “1”, the script parameter defined by <PARAM NAME=“AID” VALUE=“1”> defines an application identifier of “1” and the script parameter <PARAM NAME=“CID” VALUE=“1”> defines a client identifier of “1.”

The license parameters are transmitted to central site license server 222 for the purpose of acquiring licenses for running wireless software applications 214. As illustrated in the example embodiment described above, license parameters transmitted 35 preferably include vendor identification, application identification, and client identification information. If the requested licenses are within the limits stored in license detail database 229, the requested licenses are issued. The configuration and license parameters encoded in the Web page and the XML document requested by the remote application server program 212 are preferably provided to the central site application server 220 by a system administrator using administrator computer 240.

In one embodiment, all remote site computers 210 in the wireless system 100 are to receive the same set of wireless application software 214. In this embodiment, only one parameter-embedded Web page is required since only one set of licensing parameters and one URL for one XML configuration file is needed to specify the only one set of configuration and license parameters.

In an alternative embodiment, wireless system 100 may download different sets of wireless application software 214 to different remote sites 110, tailoring wireless application software 214 to the needs of each remote site 110. In this embodiment, a plurality of parameter-embedded Web pages, each embedded with different license parameters and URL, may be used to provide each site with the appropriate package of software.

To ensure that a particular remote site computer 210 downloads the right Web page containing the correct license parameters and URL for remote site computer 210, central site application server 220 preferably prompts the end-user to identify the remote site computer 210 before transmitting the corresponding parameter-embedded Web page to that remote site. In this way, a unique set of wireless application software specifically tailored to the needs of a particular remote site may be downloaded.

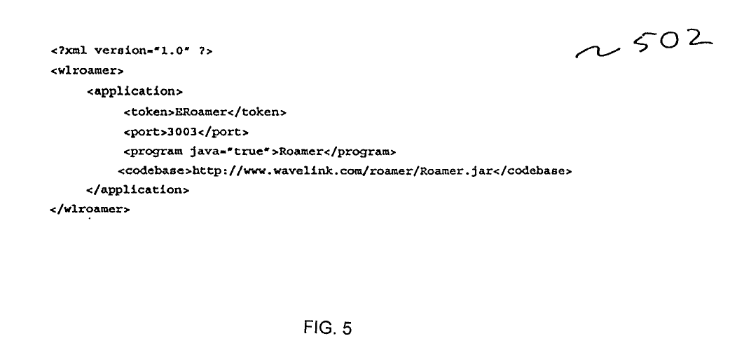

A preferred XML document is illustrated in FIG. 5. As shown in FIG. 5, the XML configuration file 502 specifies the wireless application software to be downloaded and its URL, which preferably refers to central site application server 220. In step 426, using the information contained in XML configuration file 502, wireless application server program 212 downloads wireless application software and/or new versions of wireless application software already installed at remote site computer 210 into a temporary file on remote site computer 210. To do so, wireless application server program 212 sends a request to download files to the central site application server 220. Central site application server 220 searches the information stored in account profile and history database 221 to determine the version of wireless application software appropriate for the operation environment at the remote site computer 210 and mobile devices 230. The information stored in account profile and history database 221 is also used to determine whether to update wireless application software 214 already installed at remote site computer 210 and mobile devices 230. After downloading and/or updating wireless application software, remote site computer 210 then transmits to central site application server 220 a receipt for all files received and processed, which is used to update account profile and history database 221 (step 428).

In step 430, remote application server program 212 contacts and transmits license parameters to central site license server 222. In step 432, central site license server 222 parses the license parameters transmitted and queries license detail database 229 to determine whether a license is available to the remote site for each of the wireless applications software downloaded using information stored in its database. If a license is unavailable, central site license server 222 sends an error message to remote site computer 210 (Step 434). If licenses are available, license server 222 provides licenses to application server program 212 in step 436 by sending an authorization code encoded in an XML document. Application server program 212 decodes the XML document to extract the authorization code and provides the code to each locked wireless application to unlock the application and enable the licensed features.

In step 438, application server program 212 configures the wireless application software to run with the downloaded licenses. In step 440, application server program 212 initializes wireless application software 214 on remote site computer 210. Wireless application software 214 then opens a defined TCP/IP port and begins listening for mobile device connections in step 442. In step 444, when a connection arrives, wireless software application 214 initiates the configured wireless software applications.

In step 446, application server program 212 transmits to mobile devices 230 wireless application software and configuration data as well as any updates. In step 448, mobile devices 230 then transmit a receipt of files received and processed to application server program 212, which then transmits the receipts to central site application server 220 to update account profile and history database 221.

Central site application server 220 preferably interoperate with remote site computer 210 and mobile device 230 using three-tier application software installed using the above method. At predesignated points, application server program 212 synchronizes data at all three sites (step 450). Data synchronized preferably includes operation data, fault logs, system diagnostics, pre-set trend data, and business data.

The three tiered structure of the Internet-deployed wireless system allows efficient synchronization of data. Specifically, mobile device 230 transmits data to remote site computer 210. Remote site computer 210 then caches, processes and filters the data before transmission to central site 120. In this way, remote site computer 210 pre-processes and filters data flow to the central site 120 so that processing power usage at central site 120 is maximized. Additional tiers may be accommodated, such as a web server between central site application server and remote site application server, and/or a database server behind central site application server.

When end-user determines that the wireless application software 214 should be terminated, application server program 212 indicates to central site application server 220 over the Internet that the wireless application software 214 is to terminate in step 452. In step 454, all cached data is processed and synchronized, all applications terminate, and all licenses expire. Depending on the license configuration, these licenses may then be available for deployment elsewhere.

It should be emphasized that the process of deployment and operation of the wireless system as described above in connection with FIGS. 4A-4C, including downloading and execution of wireless application software 212 and downloading and execution of wireless application software 214, are all done using a Web browser and without the need for skilled technicians.

While the invention has been described in conjunction with specific embodiments, it is evident that numerous alternatives, modifications, and variations will be apparent to those skilled in the art in light of the forgoing descriptions.

What is claimed is:

1. A wireless application server system comprising digital data stored on one or more storage media, the data further comprising:
an application server program configured to be downloaded to one or more remote wireless application server computers and to execute on the one or more remote wireless application server computers, the application server program being further configured to cause the one or more remote application server computers to download and to install one or more wireless application software components on the one or more remote wireless application server computer;
the one or more wireless application server programs being configured to transmit to one or more portable devices one or more client applications and to cause the one or more portable devices to install the one or more client applications;
the client applications being configured to communicate with the local wireless application server computer over a wireless network.

2. The wireless application server system of claim 1, further comprising a license server configured to update a database of license information in response to execution of the wireless application software and to cause notifications of charges to be generated based on the license information.

3. The wireless application server system of claim 1, further comprising a central application server configured to transmit the application server program and the one or more wireless application software to the one or more local wireless application server computers.

4. The wireless application server system of claim 1, wherein the application server program is further configured to download and to install a different set of wireless application server on different local wireless application server computers.

5. The wireless application server system of claim 1, wherein the data further comprises application data resulting from execution of the wireless server applications.

6. The wireless application server system of claim 5, wherein the application data is processed and filtered by the one or more local application server computers before transmitting the pre-processed and filtered data to the central application server.

7. The wireless application server system of claim 1, wherein the application server program is further configured to cause the one or more local application server computers to update one or more wireless application software programs on the one or more local wireless application server computers.
